(19) United States
(12) Patent Application Publication
(10) Pub. No.: US 2008/0318622 A1
(43) Pub. Date: Dec. 25, 2008

(54) Handheld intelligent mobile and fixed wireless device

(76) Inventor: Tsui-Yun Jen, Xin Dian City (TW)

Correspondence Address: CHARLES E. BAXLEY, ESQUIRE, 90 JOHN STREET, SUITE 309, NEW YORK, NY, 10038, US

(21) Appl. No.: 12/148,931

(22) Filed: Apr. 22, 2008

(30) Foreign Application Priority Data
Jun. 20, 2007 (TW) 096122022

(51) Int. Cl. H04M 1/02

(52) U.S. Cl. 455/552.1

(57) ABSTRACT

A handheld intelligent mobile and fixed wireless device includes a central processing unit (CPU), and an image module, a wireless transceiver module, a vector signal sensing module, a global positioning system (GPS) module and a short-distance wireless communication module, all of which are connected to the CPU. The CPU integrates and controls information and signals provided by each module and a mobile phone so that the device can immediately transmit an image and a message of a person or an article, or provide a positioning function, a tracking function, an identification identifying function, a communicating function, a monitoring function, a managing function and a remote control function.

### BACKGROUND OF THE INVENTION

1. Field of the Inventions

The invention relates to a wireless device, and more particularly to a handheld wireless device capable of providing communicating, data transmitting, positioning, tracking, monitoring and managing functions.

2. Description of the Related Art

A typical mobile phone has the functions of receiving and transmitting wireless signals and audio signals, and thus can perform the bidirectional audio communication in a mobile state. With the increase of the bandwidth, the mobile phone has been converted from the conventional audio mode into the audio/video mode. When the audio/video mode is to be entered, the signal system of the mobile phone has to be changed. However, the cost is increased.

A global positioning system (GPS) is widely applied to the fleet management or the logistics management, or even to the positioning and the tracking of the personal position. Taking the fleet management as an example, a satellite signal receiver is installed in a vehicle so that the position of the vehicle can be determined. However, once the vehicle goes indoors or enters a shield, the satellite positioning is disabled. In other words, the tracking fails as the person or the article goes indoors or enters the shield.

Taiwan Patent No. M287479 discloses a remote safety guard apparatus for timely transmitting messages. The safety guard apparatus includes an input device disposed in a handheld digital device, a reply device for displaying a state of the handheld device, a signal transceiver for connecting the handheld digital device to a monitor end in a wireless transmission manner; and a clock module for providing the system time. When the client is being tracked, the satellite positioning is used for signal tracking. However, the apparatus does not have the precise navigation and positioning effects, and cannot immediately transmit the image.

Taiwan Patent No. M300927 discloses a handheld wireless tracking apparatus using the wireless communication network (ZigBee) to detect a portable to-be-detected device. The handheld wireless tracking apparatus includes a microprocessor, a wireless transceiver module and an information display unit. The wireless transceiver module has at least three directional antennas and is connected to the microprocessor. The detecting range of the wireless transceiver module covers 360 degrees around the handheld device. The information display unit receives the instruction of the microprocessor and displays the orientation and the position of the portable to-be-detected device. However, the network in this patent is a small area network so that the long-distance tracking and positioning cannot be performed and no image transmitting function can be obtained. In addition, the device disposed at the detecting end in this patent includes three directional antennas, and the handheld device at the to-be-detected end includes one omni antenna. The detecting method is to determine the direction of the to-be-detected end using the three directional antennas.

### SUMMARY OF THE INVENTION

It is therefore an object of the invention to provide an intelligent handheld wireless mobile device capable of: immediately transmitting images and messages; long-distance navigating, positioning and tracking immediately and precisely; managing and controlling in a one-to-many manner; providing an interactive game; tracking and positioning a person and an article away from the holder so that the anti-stealing function is provided; providing the real-time monitoring and watching functions of the mobile emergency call; providing the remote controller function for the home appliance; providing the emergency distress function when an accident occurs; providing the identification identifying function for a person, an article and an apparatus; providing the automatic roll call and automatic check-in functions; and providing the long/short-distance watching and monitoring functions for instrument data, sensor data and equipment data.

The invention achieves the object by providing a handheld intelligent mobile and fixed wireless device including a central processing unit (CPU), an image module, a wireless transceiver module, a vector signal sensing module, a signal sensing module, a global positioning system (GPS) module and a short-distance wireless communication (ZigBee) module. The CPU has a real-time processing unit. The image module is connected to the CPU and performs image capturing and signal converting processes. The wireless transceiver module is connected to the CPU and transmits and receives signals. The vector signal sensing module is connected to the CPU and detects a position and a movement mode of the handheld intelligent mobile and fixed wireless device. The GPS module is connected to the CPU and performs a coordinate addressing process. The short-distance wireless communication module is connected to the CPU and performs a one-to-many communication process in a small area network.

Further benefits and advantages of the present invention will become apparent after a careful reading of the detailed description with appropriate reference to the accompanying drawings.

### BRIEF DESCRIPTION OF THE DRAWINGS

The above and other objects of the present invention will become readily apparent by reference to the following detailed description when considered in conjunction with the accompanying drawings wherein:

FIG. 1 is a block diagram showing a wireless device according to the invention;

FIG. 2 is a schematic illustration showing real-time image transmission according to the invention;

FIG. 3 is a schematic illustration showing a precisely positioning operation according to the invention;

FIG. 4 is a schematic illustration showing a one-to-many management mode according to the invention;

FIG. 5a is a schematic illustration showing the wireless device of the invention serving as a remote game controller;

FIG. 5b is a schematic illustration showing the wireless device of the invention serving as an interactive remote game controller;

FIG. 6 is a schematic illustration showing the wireless device of the invention for emergency calling and real-time monitoring;

FIG. 7 is a schematic illustration showing the wireless device of the invention for data long/short-distance watching and monitoring;

FIG. 8 is a schematic illustration showing the wireless device of the invention for vehicle control system monitoring and health examining; and

FIG. 9 is a flow chart showing a method of determining a direction and a position of a to-be-detected person/article according to the invention.

### DETAILED DESCRIPTION OF THE INVENTION

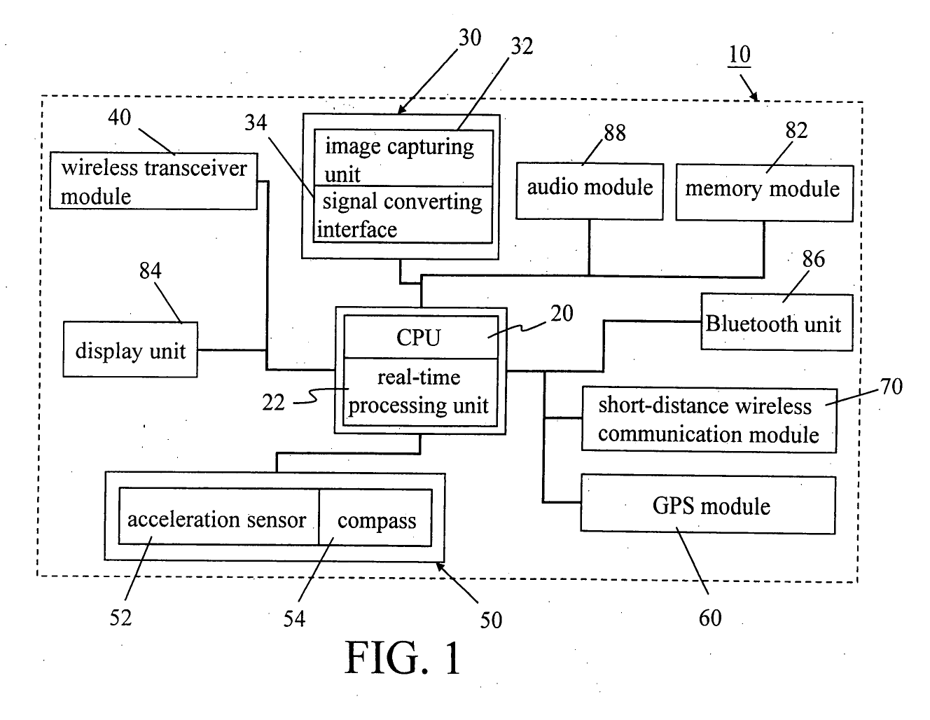

As shown in FIG. 1, a handheld wireless mobile device 10 may be, without limitation to, a mobile telephone.

The handheld wireless mobile device 10 includes a central processing unit (CPU) 20 and a real-time processing unit 22 built in the CPU 20 and connected to the CPU 20. The real-time processing unit 22 may be software or firmware.

An image module 30 includes an image capturing unit 32 and a signal converting interface 34. The image capturing unit 32 is a charge coupled device (CCD). The signal converting interface 34 is an analog-to-digital converting element. The image module 30 is connected to the CPU 20.

A wireless transceiver module 40 includes a transceiver module based on the wireless radio frequency (RF) technology including WiMax (Worldwide Interoperability for Microwave Access), GSM (Global-System for Mobile Communication), GPRS (General Packet Radio Service), CDMA (Direct Memory Access) or 3G (3rd Generation). The module can transmit and receive wireless signals. The wireless transceiver module 40 is connected to the CPU 20. Also, the wireless transceiver module 40 may include an omni antenna and at least one directional antenna.

A vector signal sensing module 50 is connected to the CPU and includes an acceleration sensor (G sensor) 52 and a compass 54. The acceleration sensor 52 detects an action force generated when the handheld wireless mobile device 10 is moved. The compass detects a moving angle of the handheld wireless mobile device 10 and analyzes the angle to determine the moving direction. The vector signal sensing module 50 is connected to the CPU 20.

A global positioning system (GPS) module 60 connected to the CPU 20 performs a coordinate addressing process.

A short-distance wireless communication (ZigBee) module 70 connected to the CPU 20 performs a one-to-many or many-to-many communication process in a small area network.

In addition, the handheld wireless mobile device 10 includes a memory module 82 and is connected to the CPU 20. The memory module 82 includes a build-in memory, such as a static random access memory (SRAM) or a flash memory, and a suitable memory card slot so that the image data captured by the image module 30 may be stored.

Also, the handheld wireless mobile device 10 connected to the CPU 20 includes a display unit 84. The display unit 84 may be a LCD screen for displaying an output or input message and performing the static or dynamic frame display.

Because the handheld wireless mobile device 10 may be a mobile phone, it may include a Bluetooth unit 86, connected to the CPU 20, for performing the wireless signal transmission. Also, the handheld wireless mobile device 10 may include an audio module 88, connected to the CPU 20, for performing audio transmitting and receiving operations.

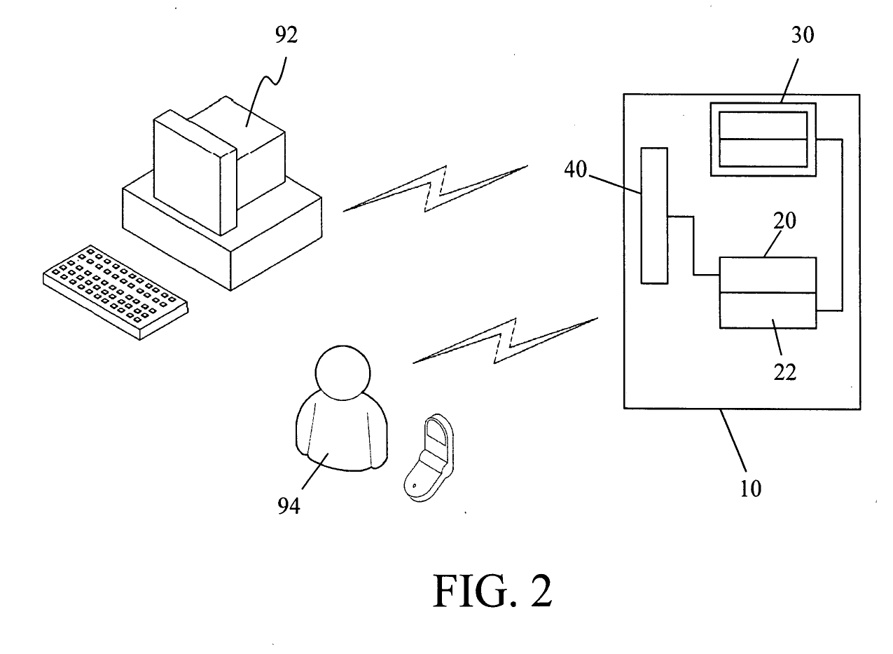

As shown in FIG. 2, the invention can provide the real-time image transmission effect. In the step of capturing an image, the handheld wireless mobile device 10 gets the image through the image capturing unit 32 in the image module 30 and converts the image.

In the step of immediately processing the image, the converted image is transmitted to the real-time processing unit 22, and then compressed, disassembled, packed, encoded, and processed in timing and time. Thus, the image occupies the smaller space of the memory to satisfy the requirement of transmitting the image with the narrower bandwidth.

In the step of immediately transmitting the image, the image processed by the real-time processing unit 22 is transmitted to a remote receiving end 92 through the wireless transceiver module 40 so that the real-time image transmission effect can be achieved.

Because the image occupies the smaller space of the memory, the image can be transmitted with the narrower bandwidth. The remote receiving end 92 may be a computer or a server. Also, the image can be transmitted to a mobile phone of a receiver 94.

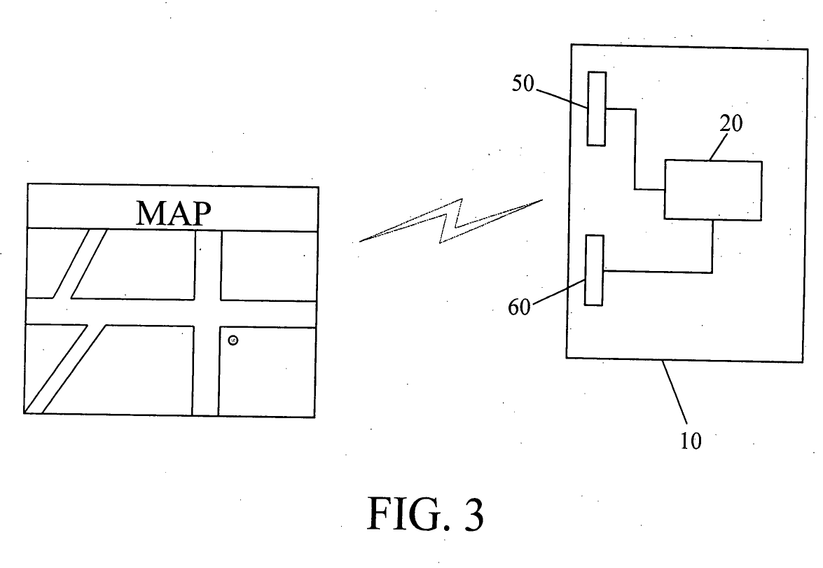

As shown in FIG. 3, when the handheld wireless mobile device 10 is enabled, the vector signal sensing module 50 can momentarily detect the mobile signal of the handheld wireless mobile device 10. Then, the mobile signal is computed by the GPS module 60 according to the prediction principle and is then coupled to a satellite map of a satellite positioning system so that the position and the travelling path of the handheld wireless mobile device 10 can be specified. The handheld wireless mobile device 10 may be disposed in a vehicle or carried by a person. The vehicle or the person going indoors or entering the shield can be precisely tracked and positioned. Similarly, if the handheld wireless mobile device 10 is disposed on goods, the condition of the goods can be momentarily monitored and cannot be restricted by the geography.

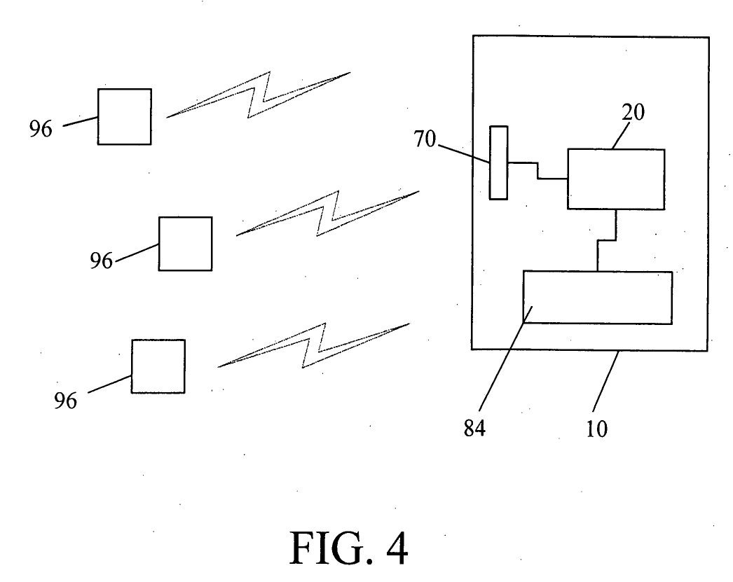

As shown in FIG. 4, the invention provides a one-to-many management function. In a small area, when a user starts the handheld wireless mobile device 10, it cooperates with the short-distance wireless communication (ZigBee) module 70 to form connections to a plurality of sub-ends 96, to receive signals from the sub-ends 96 and to display the signals on the display unit 84. The sub-end 96 has the device to be connected to the handheld wireless mobile device 10. Thus, the handheld wireless mobile device 10 and the sub-ends 96 may be controlled and managed in a one-to-many or many-to-many manner.

For example, the to-be-tracked person and article may be equipped with the wireless communication (ZigBee) modules to form the sub-ends 96. Thus, after the handheld wireless mobile device 10 is connected thereto, the state of each sub-end 96 can be obtained from the handheld wireless mobile device 10 so that the function of tracking the person and the article in the one-to-many manner can be achieved, and the anti-stealing and positioning function can be obtained.

In another used state, a home appliance, a vehicle and/or a home lock may be set as the sub-ends 96, which may be connected to the handheld wireless mobile device 10. After the parameters are properly set, the handheld wireless mobile device 10 can serve as a remote controller interacting with the home appliance, the vehicle or the lock.

Furthermore, the short-distance wireless communication (ZigBee) module 70 can work with a suitable program. In addition, an anti-collision mechanism, an identification code and address identifying mechanism, a data anti-lose mechanism, and a RF automatic broadcasting and peer-to-peer adapting mechanism can be adopted so that each sub-end 96 forms a self-organized routing network to be connected to a computer in conjunction with another handheld device at another receiving end in a wireless manner. Thus, the automatic roll call and the automatic check-in functions can be provided so that the person attendance can be automatically managed, the resource and material can be automatically inventoried, the vehicle's position can be positioned and the vehicle recorder can be automatically queried and tracked.

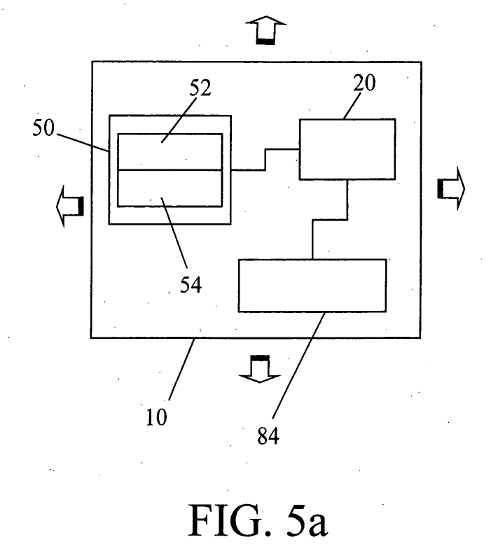

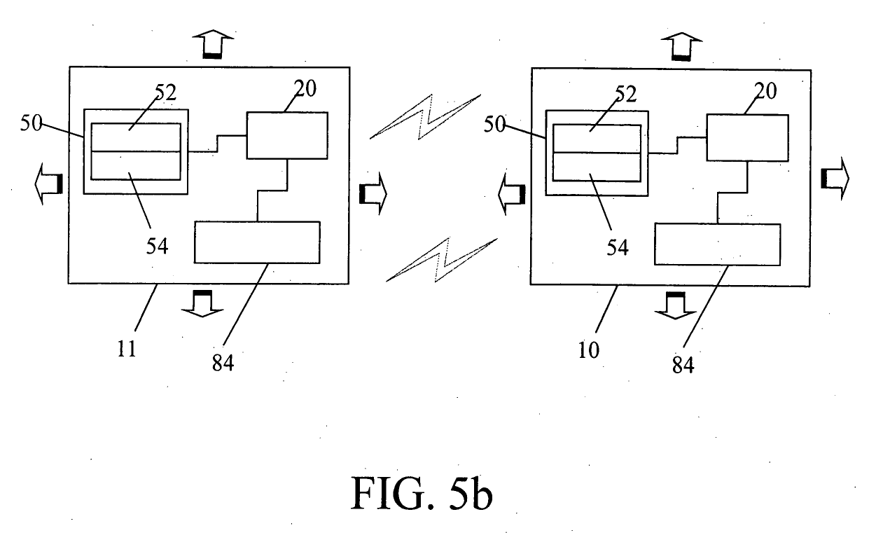

As shown in FIG. 5a, the invention serves as a remote game controller. When the user starts the handheld wireless mobile device 10 and the device 10 enters the game function, the user can rock the handheld wireless mobile device 10. At this time, the acceleration sensor 52 and the compass 54 of the vector signal sensing module 50 may respectively detect the action force and a direction or an angle, and transmit these parameters to the CPU 20 for computation. The CPU 20 cooperates with a suitable program and a frame, and the result of the game corresponding to the rocking action of the user is displayed on the display unit 84. Thus, the handheld wireless mobile device 10 may serve as the remote controller for the game.

As shown in FIG. 5b, two handheld wireless mobile devices 10 and 11 are provided to enter an interactive game mode. When two users respectively start the handheld wireless mobile devices 10 and 11 to enter the same game through the suitable network connections, the parameters corresponding to the operations of the users for rocking the handheld wireless mobile devices 10 and 11 are converted into the operations in the game, and the results corresponding to the operations are displayed on the display unit 84. For example, when two users are playing a tennis game, the operations of waving the handheld wireless mobile devices 10 and 11 are converted into the operations of waving the tennis racket.

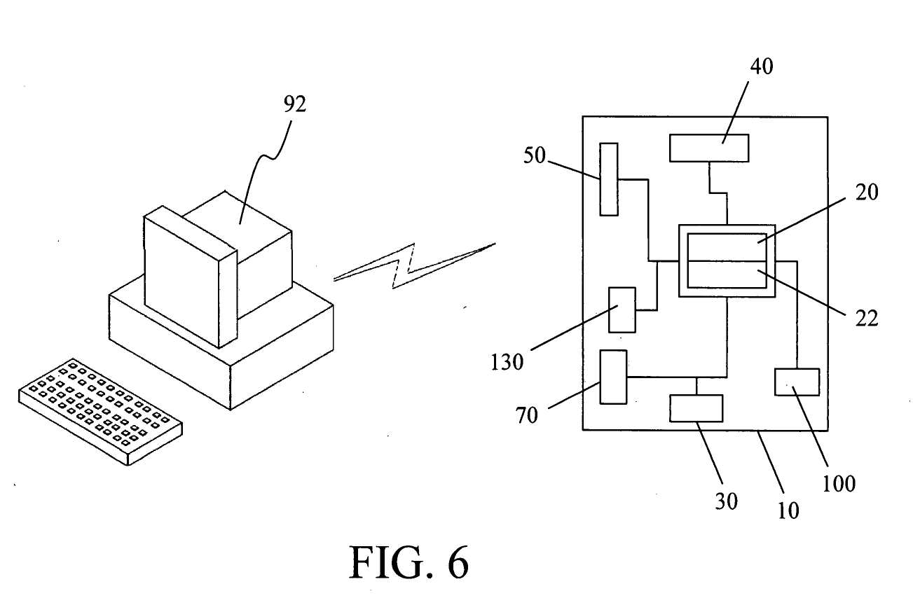

FIG. 6 is a schematic illustration showing the wireless device of the invention for emergency calling and real-time monitoring. This function cannot be enabled until an emergency button 100 is started or a sudden action force caused by the acceleration of the vector signal sensing module 50 is detected. The vector signal sensing module 50 and the image module 30 are also enabled as the function is enabled. Therefore, it is possible to detect the emergency message and the predicted position of the handheld wireless mobile device 10. The image module 30 immediately captures the image message, and a voice over internet protocol (VOIP) module 130 immediately captures the audio compression message. The messages are processed by the real-time processing unit 22 and then the wireless transceiver module 40 outputs the emergency state messages, the positioning messages and the immediately captured image messages to the remote receiving ends 92. Thus, the effects of the real-time emergency call, the real-time monitoring, the real-time watching and the real-time transmitting can be achieved.

Also, when the short-distance wireless communication (ZigBee) module 70, the wireless transceiver module 40 and the VOIP module 130 are used simultaneously, the bidirectional long/short-distance digital conversation, monitoring and recording functions can be obtained.

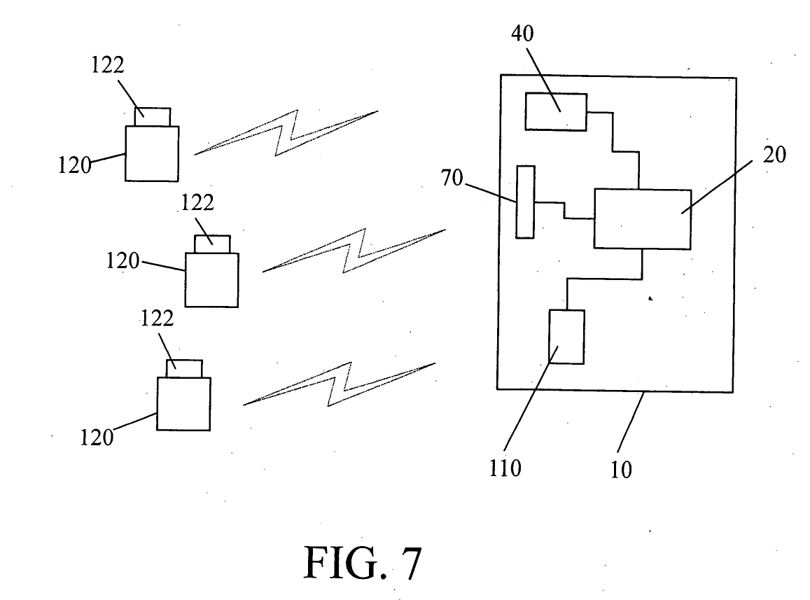

As shown in FIG. 7, the short-distance wireless communication (ZigBee) module 70, the wireless transceiver module 40 and a signal sensing module 110 for detecting an external sensor signal are combined. Sensors 122 are respectively disposed on external apparatuses 120 to detect the states of the external apparatuses 120. Thus, the handheld wireless mobile device 10 and each external apparatus 120 constitute a network, and the signal of each sensor 122 can be transmitted to the signal sensing module 110 and processed through the proper command control protocol and program. Therefore, using the handheld wireless mobile device 10 can achieve the data long/short-distance watching and monitoring functions so that the data can be immediately collected and the apparatus can be immediately diagnosed and maintained.

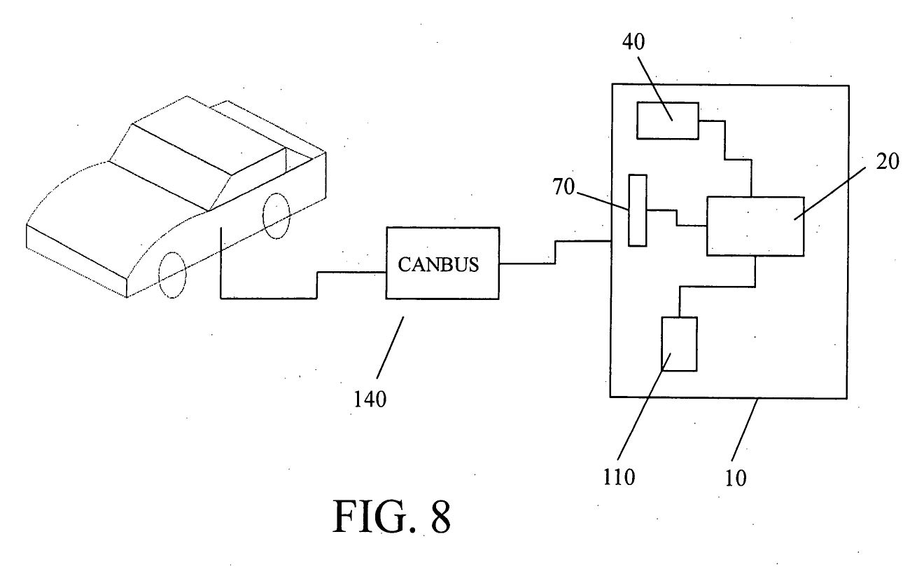

As shown in FIG. 8, the wireless device according to another embodiment of the invention is connected to a controller area network bus (CANbus) system 140. Recently, after many control assemblies used in the vehicle are computerized, the humidity and the high temperature tend to influence the stability and the precision of the circuit system. Using the wireless device of the invention can obtain various sensor signals in the vehicle and get a lot of information, such as the water temperature, the rotating speed and the like through the CANbus system 140. Then, the signals are transmitted to the rear end through the short-distance wireless communication (ZigBee) module 70 and/or the wireless transceiver module 40 so that the control system of the vehicle can monitor or analyze the condition of the vehicle.

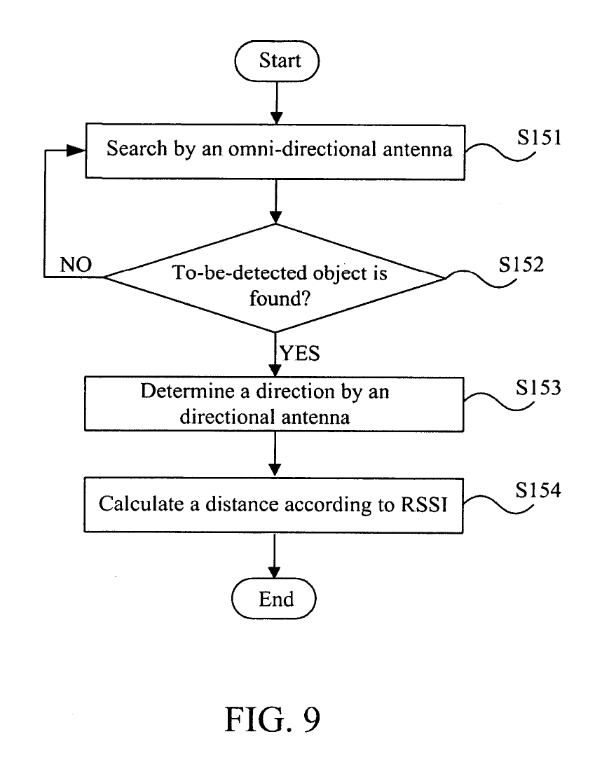

FIG. 9 is a flow chart showing a method of determining a direction and a position of a to-be-detected person/article according to the invention. The method includes the following steps S151 to S154.

In the step S151, an omni antenna of a detecting end entirely searches the ambient environment, wherein the detecting end may be a user who holds a handheld device, and the handheld device can perform the group broadcast.

In the step S152, it is determined whether a to-be-detected person or article is found. The to-be-detected person or article may have a portable device with the omni antenna, so the detecting end may be signal-connected to the to-be-detected end. In other words, the to-be-detected end may generate a reply message and output the reply message to the detecting end. However, because the omni antenna for transmitting messages is used in a small-area wireless network, it has the distance limitation. When the detecting end receives the message of the to-be-detected end, the procedure goes to the next step.

In the step S153, the directional antenna is used to determine the direction. It is to be noted that the detecting end is the user who is moving or working. Thus, if the number of the directional antenna(s) is equal to 1 or 2, the direction of the to-be-detected end may be determined according to the moving direction of the user. If the number of the directional antennas is equal to 3, the direction of the to-be-detected end can be determined according to the distribution angles of the directional antennas when the user is in a stationary state.

In the step S154, the distance from the to-be-detected end to the detecting end is determined according to the received signal strength indicator (RSSI) serving as a reference value for calculating the distance.

Therefore, the modules of the invention cooperate with one another to obtain the function of immediately transmitting images and messages; the functions of precisely satellite navigating, positioning and tracking; the basic mobile phone function; the person and the article tracking, positioning and anti-stealing functions; the one-to-many managing and controlling function; the functions of real-time monitoring and watching the accident and emergency calls; the function of identifying the identification of the person, the article or the apparatus; the functions of automatic roll call and automatic check-in; the functions of remotely/locally watching and monitoring the instrument, sensor and equipment data; the function of controlling the interactive game; and the function of serving as a remote controller of the home appliance or the game.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A handheld intelligent mobile and fixed wireless device, comprising:
a central processing unit (CPU) having a real-time processing unit;
an image module, connected to the real-time processing unit of the CPU, for performing image capturing and signal converting processes;
a wireless transceiver module, connected to the CPU, for transmitting and receiving signals;
a vector signal sensing module, connected to the CPU, for detecting a position and a movement mode of the handheld intelligent mobile and fixed wireless device;
a global positioning system (GPS) module, connected to the CPU, for performing a coordinate addressing process; and
a short-distance wireless communication (ZigBee) module, connected to the CPU, for performing a one-to-many communication process in a small area network.

2. The device according to claim 1 being a mobile phone.

3. The device according to claim 1, wherein the real-time processing unit is a program or firmware.

4. The device according to claim 1, wherein the image module comprises an image capturing unit and a signal converting interface.

5. The device according to claim 4, wherein the image capturing unit is a charge coupled device (CCD), and the signal converting interface is an analog-to-digital converting element.

6. The device according to claim 1, wherein the wireless transceiver module comprises GSM (Global System for Mobile Communication), GPRS (General Packet Radio Service) or CDMA (Code Division Multiple Access).

7. The device according to claim 1, wherein the vector signal sensing module comprises an acceleration sensor and a compass.

8. The device according to claim 1, further comprising a memory module, connected to the CPU, for storing image data captured by the image module.

9. The device according to claim 1, further comprising a display unit, connected to the CPU, for displaying various messages.

10. The device according to claim 1, further comprising a Bluetooth unit connected to the CPU.

11. The device according to claim 1, further comprising an audio module, connected to the CPU, for performing audio transmitting and receiving operations.

12. The device according to claim 1, further comprising an emergency button connected to the CPU, wherein the vector signal sensing module, the image module and the wireless transceiver module are enabled as the emergency button is enabled.

13. The device according to claim 1, further comprising a signal sensing module for performing signal detection in conjunction with the short-distance wireless communication module and the wireless transceiver module.

14. The device according to claim 1, further comprising a voice over internet protocol (VOIP) module connected to the CPU, wherein the VOIP module is combined with the short-distance wireless communication (ZigBee) module and the wireless transceiver module to form bidirectional long/short-distance digital conversation, monitoring and recording functions.

15. The device according to claim 1, further comprising a controller area network bus (CANBus) system, which cooperates with the short-distance wireless communication module and/or the wireless transceiver module to transmit system information of a vehicle.

16. The device according to claim 1, wherein the wireless transceiver module comprises an omni antenna and at least one directional antenna.
